(19) United States
(12) Patent Application Publication
(10) Pub. No.: US 2021/0237814 A1
(43) Pub. Date: Aug. 5, 2021

(54) TRACK SECTION WITH CROSSBAR MEMBER AND TRACK BELT FORMED BY SUCH TRACK SECTIONS

(71) Applicant: OLOFSFORS AB, Nordmaling (SE)

(72) Inventor: Mats FRANGÉN, Nordmaling (SE)

(21) Appl. No.: 17/049,252

(22) PCT Filed: Apr. 15, 2019
(86) PCT No.: PCT/EP2019/059648

§ 371 Date: Oct. 20, 2020

(30) Foreign Application Priority Data
Apr. 27, 2018 (EP) 18169781.4

(51) Int. Cl. B62D 55/20; B62D 55/04; B62D 55/205

(52) U.S. Cl. CPC B62D 55/202; B62D 55/205; B62D 55/04

(57) ABSTRACT

A track section (10) adapted to be linked to a plurality of similar track sections to form a track belt for mounting around the outer periphery of vehicle tyres. The track section comprises a crossbar member (11) and two lateral support members (12). A ground engageable support surface is provided on the outer side (14) of the crossbar member and comprises first and second elongated support surface sections (16, 17) extending in parallel with each other in the longitudinal direction of the crossbar member on opposite sides of a longitudinal centre line of the crossbar member. Each one of these elongated support surface sections (16, 17) is undulated, at least over a major part of its longitudinal extension, so as to form undulated support surface areas (18) with wave crests (19)and wave troughs (20) extending in the cross-direction of the crossbar member.

### FIELD OF THE INVENTION AND PRIOR ART

The present invention relates to a track section according to the preamble of claim 1, which is adapted to be linked to a plurality of similar track sections to form a track belt for mounting around the outer periphery of vehicle tyres. The invention also relates to a track belt formed by several such track sections.

Track belts which may be removably mounted around tyres on vehicles wheel are known in several different designs. Such a track belt can be used in order to obtain better friction and traction between the vehicle tyres and the ground for a vehicle, particularly on wet, slippery or muddy terrain, or in order to increase the carrying capacity of a vehicle.

A track section according to the preamble of claim 1 is previously known from WO 99/37525 A1 and WO 2011/142701 A1.

### OBJECT OF THE INVENTION

The object of the present invention is to provide a track section of the above-mentioned type having a new and favourable design.

### SUMMARY OF THE INVENTION

According to the invention, said object is achieved by means of a track section having the features defined in claim 1.

The track section according to the invention comprises:
an elongated crossbar member having a tyre-facing inner side and an opposite outer side, wherein a ground engageable support surface is provided on the outer side of the crossbar member, the track section being configured to rest against the ground via this support surface when the track section is in contact with the ground; and
two lateral support members mounted to the crossbar member at opposite end sections thereof, the support members protruding on the inner side of the crossbar member and being spaced apart to allow a tyre to be received between the support members with the crossbar member extending across and being in contact with the envelope surface of the tyre.

Said support surface on the crossbar member comprises a first elongated support surface section provided on an elongated first part of the crossbar member and a second elongated support surface section provided on an elongated second part of the crossbar member, the first and second elongated support surface sections extending in parallel with each other in the longitudinal direction of the crossbar member on opposite sides of a longitudinal centre line of the crossbar member, wherein each one of these elongated support surface sections is undulated, at least over a major part of its longitudinal extension, so as to form undulated support surface areas with wave crests and wave troughs extending in the cross-direction of the crossbar member.

The undulations on said first and second elongated support surface sections will improve the grip between the crossbar member and the ground when the crossbar member is in contact with the ground. Furthermore, the undulated support surface areas may at the same time form rather smooth and large interfaces between the crossbar member and the ground, which will give the track section a good carrying capacity and which also implies that the track section will be able to bear against the ground in a gentle manner through a rather large interface area. A large area of the interface between the crossbar member and the ground will give a low surface pressure on the ground from the crossbar member, which in its turn will reduce the damages to the ground caused by the crossbar member.

According to an embodiment of the invention, the wave crests and wave troughs on the first elongated support surface section are offset in relation to the wave crests and wave troughs on the second elongated support surface section as seen in the longitudinal direction of the crossbar member, wherein each wave crest on the first elongated support surface section is located opposite a wave trough on the second elongated support surface section, and vice versa. This arrangement of the wave crests and wave troughs will give improved grip between the crossbar member and the ground.

According to another embodiment of the invention, each elongated support surface section comprises two such undulated support surface areas, which are spaced apart as seen in the longitudinal direction of the elongated support surface section and separated from each other by a non-undulated intermediate support surface area located in the middle of the elongated support surface section. Each one of the above-mentioned elongated first and second parts of the crossbar member is subjected to the highest stress at its middle. Furthermore, there is a risk for stress concentration in the wave crests formed in the elongated first and second parts of the crossbar member. By avoiding undulations at the middle of the elongated first and second parts of the crossbar member there is no risk for stress concentration at the middle of these parts where the stress is at its highest, which in its turn will reduce the risk for breakage of the crossbar member.

Another embodiment of the invention is characterized in:
that the crossbar member comprises an elongated third part located between said first and second parts of the crossbar member, wherein the first and second parts of the crossbar member are separated from each other by the intermediate third part of the crossbar member; and
that at least one tyre-engaging element protrudes on the inner side of the crossbar member in the area between the support members, this tyre-engaging element being provided on or formed by said third part of the crossbar member and being configured for engagement with the envelop surface of a tyre received between the support members.

The tyre-engaging element on the crossbar member will give improved grip between the crossbar member and a tyre received between the lateral support members of the track section.

Further advantageous features of the track section according to the present invention will appear from the description following below and the dependent claims.

The invention also relates to a track belt having the features defined in claim 14.

### BRIEF DESCRIPTION OF THE DRAWING

With reference to the appended drawing, a specific description of embodiments of the invention cited as examples follows below. In the drawings:

FIG. 1 is a perspective view of a track section according to an embodiment of the present invention,

FIG. 2 is a perspective view from another direction of the track section of FIG. 1,

FIG. 3 is a lateral view of the track section of FIG. 1,

FIG. 4 is a planar view of the track section of FIG. 1,

FIG. 5 is a cross-sectional view of the track section of FIG. 1,

FIG. 6 is a perspective view of a track belt formed by interconnected track sections of the type illustrated in FIGS. 1-5, with the track belt mounted around the outer periphery of two vehicle tyres, and

FIG. 7 is a lateral view of the track belt and vehicle tyres of FIG. 6.

### DETAILED DESCRIPTION OF EMBODIMENTS OF THE INVENTION

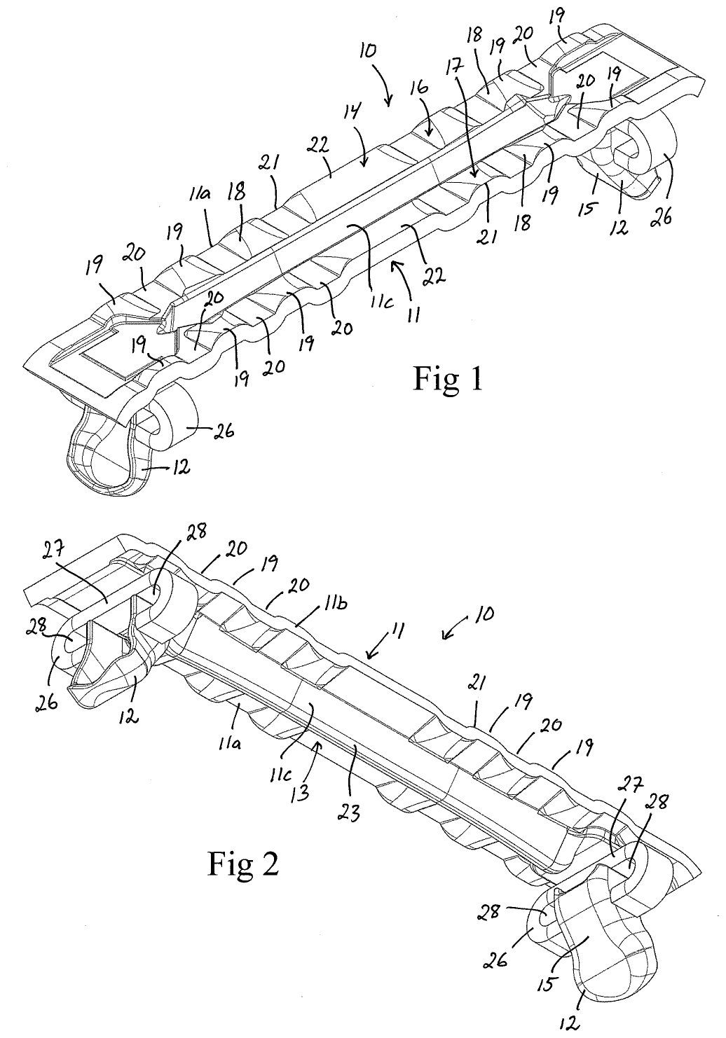

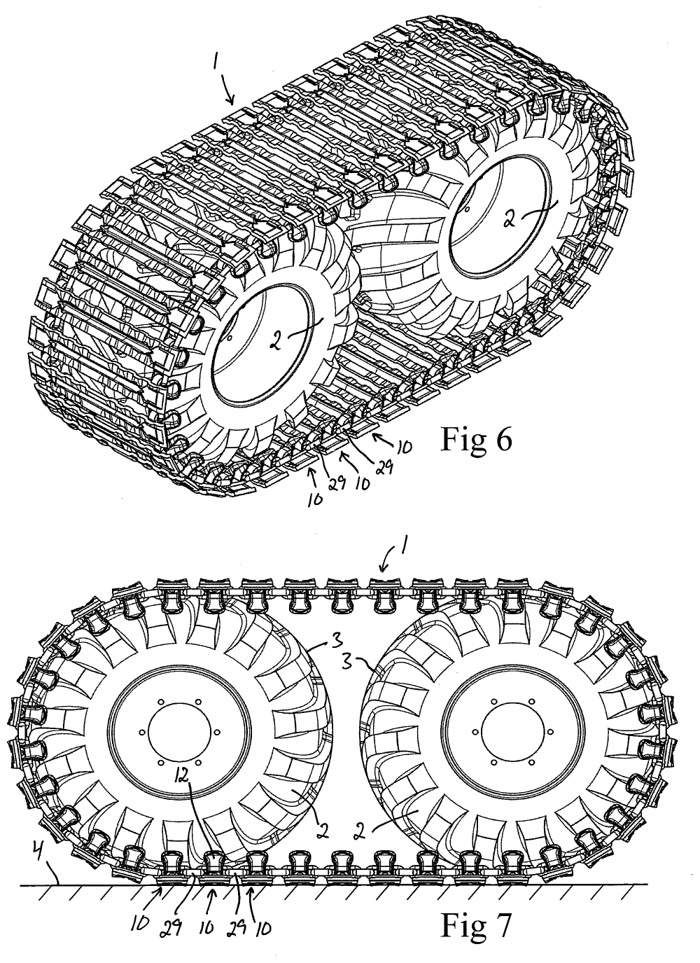

A track section 10 according to an embodiment of the present invention is illustrated in FIGS. 1-5. This track section 10 is to be linked to a plurality of similar track sections to form a flexible track belt 1 (see FIGS. 6 and 7) for mounting around the outer periphery of vehicle tyres 2. The track section 10 comprises an elongated crossbar member 11 and two lateral support members 12 mounted to the crossbar member 11 at opposite end sections thereof. The crossbar member 11 has a tyre-facing inner side 13 and an opposite outer side 14. Thus, said inner side 13 is configured for engagement with the envelope surface 3 of a vehicle tyre 2 (as schematically illustrated in FIG. 3), whereas said outer side 14 is configured for engagement with the ground 4.

The support members 12 protrude on the inner side 13 of the crossbar member 11. The support members 12 are spaced apart in the longitudinal direction of the crossbar member 11 to allow a tyre 2 of a vehicle wheel to be received between the support members 12 with the crossbar member 11 extending across and being in contact with the envelope surface 3 of the tyre 2 and with the support members 12 facing a respective one of the two opposed sidewalls 5 of the tyre, as illustrated in FIG. 3, where the lower part of a tyre 2 is schematically illustrated in broken lines. Each support member 12 has a first side 12a (see FIG. 3) facing the other support member and an opposite second side 12b facing away from the other support member. A contact surface 15 is provided on said first side 12a of each support member for engagement with the outer surface of a tyre 2 received between the support members 12. In the illustrated embodiment, the support members 12 are designed in the manner described in closer detail in WO 2011/142701 A1. However, the support members 12 may as an alternative have any other suitable design.

A ground engageable support surface is provided on the outer side 14 of the crossbar member 11, wherein the track section 10 is configured to rest against the ground 4 via this support surface when the track section 10 is in contact with the ground 4. The support surface comprises a first elongated support surface section 16 provided on an elongated first part 11a of the crossbar member 11 and a second elongated support surface section 17 provided on an elongated second part 11b of the crossbar member 11, wherein the first and second elongated support surface sections 16, 17 extend in parallel with each other in the longitudinal direction of the crossbar member 11 and at a distance from each other on opposite sides of a longitudinal centre line of the crossbar member

In order to improve the grip against the ground, each one of the elongated support surface sections 16, 17 is undulated, at least over a major part of its longitudinal extension, so as to form undulated support surface areas 18 with wave crests 19 and wave troughs 20 extending in the cross-direction of the crossbar member 11. Hereby, undulated edges 21 are formed along the opposite long sides of the crossbar member 11. These undulated edges 21 improve the grip between the crossbar member 11 and the ground 4 when the crossbar member is in contact with the ground.

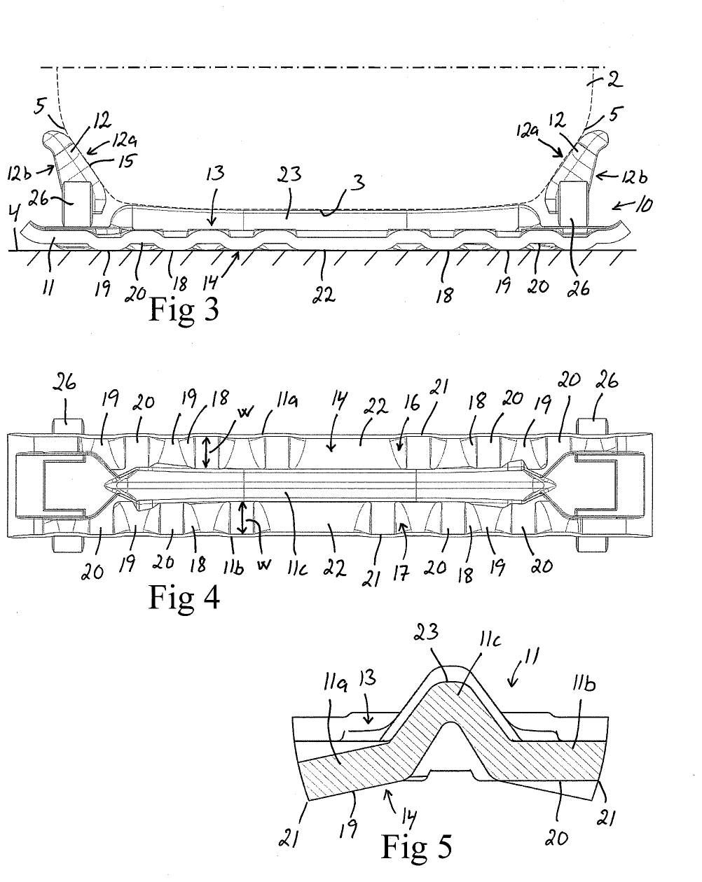

Each one of said undulated support surface areas 18 has a width w (see FIG. 4) of at least 3 cm, preferably at least 5 cm.

The wave crests 19 and wave troughs 20 on the first elongated support surface section 16 are preferably offset in relation to the wave crests 19 and wave troughs 20 on the second elongated support surface section 17 as seen in the longitudinal direction of the crossbar member 11, as illustrated in FIGS. 1-5, wherein each wave crest 19 on the first elongated support surface section 16 is located opposite a wave trough 20 on the second elongated support surface section 17 and each wave crest 19 on the second elongated support surface section 17 is located opposite a wave trough 20 on the first elongated support surface section 16. However, as an alternative, the wave crests 19 on the first elongated support surface section 16 may be arranged directly opposite the wave crests 19 on the second elongated support surface section 17.

In the embodiment illustrated in FIGS. 1-4, each elongated support surface section 16, 17 comprises two undulated support surface areas 18, which are spaced apart as seen in the longitudinal direction of the elongated support surface section 16, 17 and separated from each other by a non-undulated intermediate support surface area 22 located in the middle of the elongated support surface section 16, 17. Each one of the undulated support surface areas 18 is preferably provided with at least three wave crests 19 which are separated from each other by intermediate wave troughs 20.

The crossbar member 11 also comprises an elongated third part 11c located between said first and second parts 11a, 11b of the crossbar member, wherein the first and second parts 11a, 11b of the crossbar member are separated from each other by the intermediate third part 11c of the crossbar member. At least one tyre-engaging element 23 protrudes on the inner side 13 of the crossbar member 11 in the area between the support members 12, wherein this tyre-engaging element 23 is provided on or formed by said third part 11c of the crossbar member and configured for engagement with the envelop surface 3 of a tyre 2 received between the support members 12. In the illustrated embodiment, the crossbar member 11 is provided with one continuous such tyre-engaging element 23 formed as a depression in said third part 11c of the crossbar member. As an alternative, the third part 11c of the crossbar member may be essentially flat, wherein one or more tyre-engaging elements may be fixed to this part 11c by welding.

In the embodiment illustrated in FIGS. 1-5, each wave trough 20 has an essentially flat bottom surface. However, the bottom surface of one or more of the wave troughs 20 may as an alternative be curved as seen in the longitudinal direction of the crossbar member 11.

In the embodiment illustrated in FIGS. 1-5, each wave crest 19 is inclined downwards towards the longitudinal centre line of the crossbar member 11, as clearly illustrated in FIG. 5. The above-mentioned non-undulated intermediate support surface areas 22 are in the same manner inclined downwards towards the longitudinal centre line of the crossbar member 11. The purpose of this inclination of the wave crests 19 and the intermediate support surface areas 22 is to avoid the formation of sharp pockets on the inner side 13 of the crossbar member 11 where debris, mud and the similar could get stuck and impair the grip between the crossbar member 11 and the envelop surface 3 of a tyre 2 received between the support members 12.

Each one of said first and second elongated parts 11a, 11b of the crossbar member preferably has a thickness of 10-20 mm. The length of the crossbar member 11 is preferably between 600 and 1400 mm and the width of the crossbar member 11 is preferably between 100 and 200 mm. The crossbar member 11 is made of steel and is with advantage formed in one piece.

In the illustrated example, each support member 12 is secured to an end section of the crossbar member 11 through a C-shaped connection member 26, a so-called link hook, which is secured to the crossbar member 11 by welding. The support member 12 rests against a base part 27 of the connection member 26 and is secured to this base part 27 by welding. A first opening 28 (see FIG. 4) for receiving a first link element 29 (see FIG. 7) is formed on a first side of the support member 12 between the connection member 26 and a first lateral wall of the support member 12 and a second opening 28 for receiving a second link element 29 is formed on the opposite side of the support member 12 between the connection member 26 and a second lateral wall of the support member 12.

Several track sections 10 of the type described above are interconnected by means of link elements 29 to form a flexible track belt 1, as illustrated in FIGS. 6 and 7. Each link element 29 is received in an opening 28 of a connection member 26 of a first track section 10 and in an opening 28 of a connection member 26 of another adjacent track section 10. The link elements 29 will act as hinges between the track sections 10. The track section 1 is mounted around the outer periphery of two or more vehicle tyres 2 with the crossbar members 11 extending in the cross-direction of the tyres and with the support members 12 facing the tyres. The support members 12 will keep the track belt 1 correctly positioned on the tyres 2 and will prevent the track belt 1 from slipping off the tyres 2. At the part of a tyre 2 where the tyre bears against the ground 4, the sidewalls 5 of the tyre will bulge due to the load from the vehicle and the sidewalls 5 will thereby come into contact with the two opposed support members 12 of a track section 10 received between the tyre 2 and the ground 4, as illustrated in FIG. 3.

The invention is of course not in any way restricted to the embodiments described above. On the contrary, many possibilities to modifications thereof will be apparent to a person with ordinary skill in the art without departing from the basic idea of the invention such as defined in the appended claims.

1. A track section adapted to be linked to a plurality of similar track sections to form a track belt for mounting around the outer periphery of vehicle tyres, wherein the track section (10) comprises:
an elongated crossbar member (11) having a tyre-facing inner side (13) and an opposite outer side (14), wherein a ground engageable support surface is provided on the outer side (14) of the crossbar member, the track section (10) being configured to rest against the ground via this support surface when the track section (10) is in contact with the ground; and
two lateral support members (12) mounted to the crossbar member (11) at opposite end sections thereof, the support members (12) protruding on the inner side (13) of the crossbar member (11) and being spaced apart to allow a tyre (2) to be received between the support members (12) with the crossbar member (11) extending across and being in contact with the envelope surface (3) of the tyre, wherein
said support surface comprises a first elongated support surface section (16) provided on an elongated first part (11a) of the crossbar member (11) and a second elongated support surface section (17) provided on an elongated second part (11b) of the crossbar member (11), the first and second elongated support surface sections (16, 17) extending in parallel with each other in the longitudinal direction of the crossbar member (11) on opposite sides of a longitudinal centre line of the crossbar member (11), and
each one of these elongated support surface sections (16, 17) is undulated, at least over a major part of its longitudinal extension, so as to form undulated support surface areas (18) with wave crests (19) and wave troughs (20) extending in the cross-direction of the crossbar member (11).

2. A track section according to claim 1, wherein each one of said undulated support surface areas (18) has a width (w) of at least 3 cm, preferably at least 5 cm.

3. A track section according to claim 1, wherein the wave crests (19) and wave troughs (20) on the first elongated support surface section (16) are offset in relation to the wave crests (19) and wave troughs (20) on the second elongated support surface section (17) as seen in the longitudinal direction of the crossbar member (11), and
each wave crest (19) on the first elongated support surface section (16) is located opposite a wave trough (20) on the second elongated support surface section (17), and vice versa.

4. A track section according to claim 1, wherein each elongated support surface section (16, 17) comprises two such undulated support surface areas (18), which are spaced apart as seen in the longitudinal direction of the elongated support surface section (16, 17) and separated from each other by a non-undulated intermediate support surface area (22) located in the middle of the elongated support surface section (16, 17).

5. A track section according to claim 1, wherein each one of said undulated support surface areas (18) is provided with at least three wave crests (19) which are separated from each other by intermediate wave troughs (20).

6. A track section according to claim 1, wherein each wave trough (20) has an essentially flat bottom surface.

7. A track section according to claim 1, wherein each wave crest (19) is inclined downwards towards the longitudinal centre line of the crossbar member (11).

8. A track section according to claim 1, wherein said first and second elongated parts (11a, 11b) of the crossbar member have a thickness of 10-20 mm.

9. A track section according to claim 1, wherein:
the crossbar member (11) comprises an elongated third part (11c) located between said first and second parts (11a, 11b) of the crossbar member,
the first and second parts (11a, 11b) of the crossbar member are separated from each other by the intermediate third part (11c) of the crossbar member, and
at least one tyre-engaging element (23) protrudes on the inner side (13) of the crossbar member (11) in the area between the support members (12), this tyre-engaging element (23) being provided on or formed by said third part (11c) of the crossbar member and being configured for engagement with the envelop surface (3) of a tyre (2) received between the support members (12).

10. A track section according to claim 9, wherein said tyre-engaging element (23) is formed as a depression in said third part (11c) of the crossbar member.

11. A track section according to claim 1, wherein the crossbar member (11) has a length of 600-1400 mm.

12. A track section according to claim 1, wherein the crossbar member (11) is formed in one piece.

13. A track section according to claim 1, wherein the crossbar member (11) is made of steel.

14. A track belt for mounting around the outer periphery of vehicle tyres, wherein the track belt (1) is formed by several track sections (10) according to claim 1 connected to each other by means of link elements (29).

15. A track section according to claim 2, wherein the wave crests (19) and wave troughs (20) on the first elongated support surface section (16) are offset in relation to the wave crests (19) and wave troughs (20) on the second elongated support surface section (17) as seen in the longitudinal direction of the crossbar member (11), and
each wave crest (19) on the first elongated support surface section (16) is located opposite a wave trough (20) on the second elongated support surface section (17), and vice versa.

16. A track section according to claim 15, wherein each elongated support surface section (16, 17) comprises two such undulated support surface areas (18), which are spaced apart as seen in the longitudinal direction of the elongated support surface section (16, 17) and separated from each other by a non-undulated intermediate support surface area (22) located in the middle of the elongated support surface section (16, 17).

17. A track section according to claim 3, wherein each elongated support surface section (16, 17) comprises two such undulated support surface areas (18), which are spaced apart as seen in the longitudinal direction of the elongated support surface section (16, 17) and separated from each other by a non-undulated intermediate support surface area (22) located in the middle of the elongated support surface section (16, 17).

18. A track section according to claim 2, wherein each elongated support surface section (16, 17) comprises two such undulated support surface areas (18), which are spaced apart as seen in the longitudinal direction of the elongated support surface section (16, 17) and separated from each other by a non-undulated intermediate support surface area (22) located in the middle of the elongated support surface section (16, 17).

19. A track section according to claim 16, wherein each one of said undulated support surface areas (18) is provided with at least three wave crests (19) which are separated from each other by intermediate wave troughs (20).

20. A track section according to claim 17, wherein each one of said undulated support surface areas (18) is provided with at least three wave crests (19) which are separated from each other by intermediate wave troughs (20).
